(19) United States
(12) Patent Application Publication
(10) Pub. No.: US 2008/0072428 A1
(43) Pub. Date: Mar. 27, 2008

(54) Method and system for manufacturing vehicle lid body

(75) Inventors: Toshio Emura, Hiroshima-Shi (JP); Shoji Kimoto, Hiroshima-Shi (JP); Kazuyuki Okamoto, Hiroshima-Shi (JP); Hideki Ueda, Hiroshima-Shi (JP); Tadaharu Sumida, Hiroshima-Shi (JP); Tomohide Mitsuishi, Hiroshima-Shi (JP); Michisada Kumasaki, Hiroshima-Shi (JP); Nobuyuki Shiozaki, Hiroshima-Shi (JP)

Correspondence Address: YOUNG & THOMPSON, 745 SOUTH 23RD STREET, 2ND FLOOR, ARLINGTON, VA, 22202, US

(73) Assignee: HIROTEC CORPORATION, HIROSHIMA-SHI (JP)

(21) Appl. No.: 11/521,377

(22) Filed: Sep. 15, 2006

(51) Int. Cl. B21D 53/88; B23P 11/00

(52) U.S. Cl. 29/897.2; 29/505; 29/700

(57) ABSTRACT

A to be-processed portion of an inner panel formed by stamping a steel plate is overlaid, in a thickness direction thereof, with a to-be-processed portion of a reinforcing member formed by stamping a steel plate. The inner panel and the reinforcing member are joined and integrated by a spot welding apparatus, thereby obtaining an intermediate article. A material handling robot puts off the intermediate article from the spot welding apparatus, conveys it to a pressing apparatus, and sets it against the pressing apparatus. The to-be-processed portion of the inner panel and the to-be-processed portion of the reinforcing member are subjected to piercing by the pressing apparatus.

### FIELD OF THE INVENTION

The present invention relates to a method for manufacturing a lid body for opening/closing an opening formed in a vehicle and a system for manufacturing the vehicle lid body.

### BACKGROUND ART

Conventionally, a door is arranged as a lid body for opening/closing an opening formed in each side part of, for example, an automobile. The door includes a steel-made inner panel as a lid body composing member which composes the inboard side of the door, as disclosed in Japanese Patent Application Laid Open Publication No. 2003-020845A (hereinafter referred to as Patent Document). A steel-made reinforcing member as another lid body composing member for reinforcing a mounting part of a door latch mechanism is overlaid outboard with the inner panel so that the inner panel is integrated with the reinforcing member. For integration, insertion holes for receiving screws for fixing the door latch mechanism to the door are formed in a to-be-processed portion of the inner panel, and insertion holes for receiving the screws are formed in a to-be-processed portion of the reinforcing member so as to correspond to the insertion holes of the inner panel.

For forming the insertion holes in the steel-made door composing member, as in Patent Document 1, pressing is employed widely.

Formation of the insertion holes in a steel-made door composing member, as in Paten Document 1, necessitates a step for forming the screw insertion holes in the to-be-processed portions of the inner panel and the reinforcing member and a step for integrating the inner panel and the reinforcing member. These steps must be performed by separate apparatuses because the operations therefor are quire different from each other. Accordingly, manufacture of the door in Patent Document 1 requires an operation for setting an intermediate article against apparatuses for the respective steps, an operation for putting out the intermediate article from the apparatuses, and an operation for conveying the intermediate article between the apparatuses. Meanwhile, in worksites for manufacturing the door, which necessitates a plurality of operations as above, there are demands for reducing man-hour for operation by an assembly operator as far as possible for labor saving.

In forming the inner panel or the reinforcing member as in Patent Document 1, the shape of the inner panel or the reinforcing member may deviate slightly from their proper shapes because of error. Such deviation forms a gap at a part where no gap must be formed in the design when the inner panel and the reinforcing member are overlaid with each other. Further, in integrating the inner panel and the reinforcing member, their positions may be displaced from their proper positions. In this case, the insertion holes of the inner panel and the insertion holes of the reinforcing member are displaced from their proper positions, so that they do not correspond to each other. As a result, man-hour for modification is required for making the shapes and the positions of the insertion holes to correspond to each other.

The present invention has been made in view of the above problems, and has its object of contemplating labor saving in a worksite for manufacturing a vehicle lid body and reducing man-hour for modifying a mold and the like by enabling the shapes or positions of processed traces of lid body composing members to correspond to each other even if error in the lid body composing members to be joined occurs in stamping or even if displacement of the lid body composing members occurs in joining.

### SUMMARY OF THE INVENTION

A first invention is directed to a method for manufacturing a vehicle lid body for opening/closing an opening portion formed in a vehicle, which includes: a joining step of joining and integrating by a joining apparatus a first lid body composing member and a second lid body composing member, in which a first to-be-processed portion and a second to-be-processed portion are set respectively, with the first to-be-processed portion and the second to-be-processed portion overlaid with each other in a thickness direction thereof, the first lid body composing member and the second lid body composing member being formed by stamping metal plates so as to have predetermined shapes; a setting step of putting off the first lid body composing member and the second lid body composing member, which are integrated in the joining step, from the joining apparatus, conveying them to a pressing apparatus, and setting them against the pressing apparatus by a conveying apparatus; and a pressing step of simultaneously pressing by the pressing apparatus the first to-be-processed portion of the first lid body composing member and the second to-be-processed portion of the second lid body composing member, which are set against the pressing apparatus in the setting step.

In the above arrangement, the conveying apparatus conveys the first lid body composing member and the second lid body composing member, which are integrated by the joining apparatus, and sets them against the pressing apparatus. Accordingly, the assembly operator is not required to put off the first composing member and the second composing member from the joining apparatus, to convey them to the pressing apparatus, and to set them against the pressing apparatus in a worksite for manufacturing the vehicle lid body. As a result, man-hour of the assembly operator in the worksite for manufacturing the lid body is reduced, contemplating labor saving.

In the pressing step, the pressing apparatus presses simultaneously the first to-be-pressed portion and the second to-be-pressed portion where the first lid body composing member and the second lid body composing member are integrated and overlaid with each other. Accordingly, even if error occurs in stamping the first lid body composing member or the second lid body composing member or even if displacement occurs in joining the lid body composing members, the shape and position of a processed trace of the first to-be-processed portion correspond to the shape and the position of a processed trace of the second to-be-processed portion, suppressing occurrence of material defects to reduce man-hour for modifying a mod and the like.

Referring to a second invention, the method for manufacturing a vehicle lid body of the first invention further includes the step of: forming holes by piercing the first to-be-processed portion and the second to-be-processed portion before the joining step, wherein in the joining step, the first lid body composing member and the second lid body composing member are joined and integrated by spot welding after the first lid body composing member and the second lid body composing member are positioned relatively to each other with the use of the holes formed in the first to-be-processed portion and the second to-be-processed portion as positioning references, and in the pressing step, the first to-be-processed portion and the second to-be-processed portion are subjected to flanging.

In the above arrangement, the holes are utilized for relatively positioning the first lid body composing member and the second lid body composing member, realizing reliable and easy positioning.

A third invention is directed to a system for manufacturing a vehicle lid body for opening/closing an opening portion formed in a vehicle, which includes: a joining apparatus for joining and integrating a first lid body composing member and a second lid body composing member with the first lid body composing member and the second lid body composing member overlaid with each other in a thickness direction thereof, the first lid body composing member and the second lid body composing member being formed by molding metal plates so as to have predetermined shapes; a pressing apparatus for simultaneously pressing a first to-be-processed portion of the first lid body composing member and a second to-be-processed portion of the second lid body composing member which are set respectively in parts where the first lid body composing member and the second lid body composing member are overlaid in the thickness direction thereof; and a conveying apparatus for putting off the first lid body composing member and the second lid body composing member, which are integrated by the joining apparatus, from the joining apparatus and for conveying them to the pressing apparatus.

With the above arrangement, the assembly operator is not required to put off the first lid body composing member and the second lid body composing member from the joining apparatus, to convey them to the pressing apparatus, and to set them against the pressing apparatus in the worksite for manufacturing the vehicle lid body, leading to labor saving in the worksite.

Further, the shape and the position of the processed trace of the first to-be-processed portion correspond to those of the second to-be-processed portion, suppressing occurrence of material defects to result in reduction in man-hour for modifying a mold and the like.

Referring to a fourth invention, in the system for manufacturing a vehicle lid body of the third invention, the pressing apparatus includes a processing section, the first to-be-processed portion includes a plurality of first-to-be-processed portions set in the first lid body composing member and the second to-be-processed portion includes a plurality of second to-be-processed portions set in the second lid body composing member, and the conveying apparatus conveys the first lid body composing member and the second lid body composing member so that the plurality of first to-be-processed portions and the plurality of second to-be-processed portions are set against the processing section of the pressing apparatus sequentially.

With the above arrangement, the plurality of first to-be-processed portions and the plurality of second to-be-processed portions can be pressed by a low-cost pressing apparatus including only one pressing section, saving the initial capital investment for introducing a manufacturing system.

A pressing apparatus including a plurality of pressing sections has no general versatility because the positions of the pressing sections are fixed. In contrast, the pressing apparatus including only one pressing section as in the fourth invention can presses a plurality of to-be-pressed portions one by one. Accordingly, it is unnecessary to prepare any pressing section for exchange, and to-be-processed portions of plural types of the lid bodies can be pressed by only one set of pressing apparatus, which means wide general versatility. Hence, there is no need to provide exclusive processing sections for different types of lid bodies. This suppresses the initial capital investment for introducing a manufacturing apparatus, as well.

A fifth invention is directed to a system for manufacturing a vehicle lid body for opening/closing an opening portion formed in a vehicle, which includes: a jig for holding a first lid body composing member and a second lid body composing member with the first lid body composing member and the second lid body composing member overlaid with each other in a thickness direction thereof, the first lid body composing member and the second lid body composing member being formed by stamping metal plates so as to have predetermined shapes; a joining apparatus for joining and integrating the first lid body composing member and the second lid body composing member which are held by the jig; and a pressing apparatus mounted to the jig for simultaneously pressing a first to-be-processed portion and a second to-be-processed portion which are set respectively in parts of the first lid body composing member and the second lid body composing member where the first lid body composing member and the second lid body composing member are overlaid with each other in the thickness direction thereof.

The above arrangement enables the pressing apparatus mounted to the jig to press the first lid body composing member and the second lid body composing member which are integrated and are held by the jig. Accordingly, the assembly operator is not required to put off the first lid body composing member and the second lid body composing member from the joining apparatus, to convey them to the pressing apparatus, and to set them against the pressing apparatus in the worksite for manufacturing the vehicle lid body. As a result, labor saving can be contemplated in the worksite.

Further, similarly to the third invention, the shape and the position of the processed trace of the first to-be-processed portion correspond to those of the processed trace of the second to-be-processed portion, suppressing occurrence of material defects to result in reduction in man-hour for modifying a mold and the like.

A sixth invention is directed to a system for manufacturing a vehicle lid body for opening/closing an opening portion formed in a vehicle, which includes: a jig for holding a first lid body composing member and a second lid body composing member with the first lid body composing member and the second lid body composing member overlaid with each other in a thickness direction thereof, the first lid body composing member and the second lid body composing member being formed by stamping metal plates so as to have predetermined shapes; a joining apparatus for joining and integrating the first lid body composing member and the second lid body composing member which are held by the jig; a movable pressing apparatus for simultaneously pressing a first to-be-processed portion and a second to-be-processed portion which are set respectively in parts of the first lid body composing member and the second lid body composing member where the first lid body composing member and the second lid body composing member are overlaid with each other in the thickness direction thereof; and a moving apparatus for moving the pressing apparatus.

The above arrangement enables the pressing apparatus moved by the moving apparatus to press simultaneously the first to-be-processed portion and the second to-be-processed portion of the first lid body composing member and the second lid body composing member which are held by the jig and are integrated. Accordingly, the assembly operator is not required to put off the first lid body composing member and the second lid body composing member from the joining apparatus, to convey them to the pressing apparatus, and to set them against the pressing apparatus in the worksite for manufacturing the vehicle lid body. As a result, labor saving can be contemplated in the worksite.

Further, similarly to the third invention, material defects occurs less, and man-hour for modifying a mold and the like can be reduced.

Referring to a seventh invention, in the system for manufacturing a vehicle lid body of the sixth invention, the pressing apparatus includes a pressing section, the first to-be-processed portion includes a plurality of first-to-be-processed portions set in the first lid body composing member and the second to-be-processed portion includes a plurality of second to-be-processed portions set in the second lid body composing member, and the moving apparatus moves the pressing apparatus including the processing section to the plurality of first to-be-processed portions and the plurality of second to-be-processed portions sequentially.

With the above arrangement, similarly to the fourth invention, a low-cost pressing apparatus can be employed for the pressing step, and no exclusive processing sections are required for different types of lid bodies. Hence, the initial capital investment for introducing a manufacturing system can be suppressed.

In the aforementioned manufacturing methods, a body face portion extending along a face where an opening is formed in the vehicle and a lateral face portion extending in a direction across the body face portion from the periphery of the body face portion may be formed continuously by pressing at least one of the first lid body composing member and the second lid body composing member before the joining step so that the to-be-processed portion is set in the lateral face portion.

With the above arrangement, it is unnecessary to subject the to-be-processed portion in the lateral face portion to processing in pressing the lid body composing member including the lateral face portion before the joining step, and the to-be-processed portion can be processed simultaneously with the other to-be-processed portion in the pressing step thereafter. This eliminates the need of a cam die for forming the to-be-processed portion in the lateral face portion in a mold for pressing the lid body composing member including the lateral face portion before the joining step, simplifying the structure of the mold. As a result, trouble in the mold occurs less, and the maintainability for the mold can be enhanced.

Further, in the above manufacturing methods, the to-be-processed portion set in the lateral face portion may be pressed in the pressing step so as to have a protrusion protruding in the thickness direction of the lateral face portion from the lateral face portion.

With the above arrangement, the protrusion protruding from the lateral face portion can be formed in the to-be-processed portion in the lateral face portion after the joining step. This means that: in the case where one of the lid body composing members is stamped so as to have a predetermined shape in a place apart from the joining apparatus before the joining step, and then, the one lid body composing member is conveyed to the joining apparatus for joining it with the other lid body composing member, no protrusion protruding from the lateral face portion is formed yet in conveyance, and therefore, no protrusion presents no obstacle, enabling a multiplicity of the one lid body composing members to be overlaid in a limited space of a pallet or the like for conveyance. With no protrusion protruding from the lateral face portion of the one lid body composing member in conveyance, flaws such as an indentation and the like are hardly formed at the lateral face portion even if the lateral face portions of the overlaid lid body composing members are in contact with each other. This eliminates the need to interpose a cushion material between the overlaid lid body composing members, enabling a multiplicity of the one lid body composing members to be overlaid within a limited space for conveyance, as well. Hence, distribution costs can be reduced.

Referring to another method for manufacturing a vehicle lid body for opening/closing an opening portion formed in a vehicle, the method may include: a primary processing step of obtaining a first lid body composing member and a second lid body composing member in which a first to-be-processed portion and a second to-be-processed portion are set respectively by stamping metal plates so as to have predetermined shapes, and pressing the first to-be-processed portion; a joining step of joining and integrating by a joining apparatus the first lid body composing member and the second lid body composing member, which are obtained in the primary processing step, with the first to-be-processed portion and the second to-be-processed portion overlaid with each other in a thickness direction thereof; a setting step of, by a conveying apparatus, putting off the first lid body composing member and the second lid body composing member, which are integrated in the joining step, from the joining apparatus, conveying them to a pressing apparatus, and setting them against the pressing apparatus; and a pressing step of pressing the second to-be-processed portion of the second lid body composing member set against the pressing apparatus together with the first lid body composing member so as to correspond to a processed trace of the first to-be-processed portion.

With the above arrangement, similarly to the first invention, labor saving in the worksite for manufacturing the lid body can be contemplated. Further, in the pressing step, the pressing apparatus presses the second to-be-processed portion overlaid with the first to-be-processed portion by integrating the first lid body composing member and the second lid body composing member so as to correspond to the processed trace of the first to-be-processed portion. Accordingly, the shape and the position of the processed trace of the first to-be-processed portion correspond to those of the processed trace of the second to-be-processed portion. As a result, material defect occur less, reducing man-hour for modifying the mold and the like.

In the second lid body composing member, before the joining step, a body face portion extending along a face where an opening is formed in the vehicle and a lateral face portion extending in a direction across the body face portion from the periphery of the body face portion may be formed continuously by pressing so that the second to-be-processed portion is set in the lateral face portion.

With the above arrangement, it is unnecessary to subject the second to-be-processed portion in the lateral face portion to processing in pressing the second lid body composing member before the joining step, and the second to-be-processed portion can be processed simultaneously with the first to-be-processed portion in the pressing step thereafter. This eliminates the need of a cam die for stamping the second to-be-processed portion in the lateral face portion in a mold for pressing the second lid body composing member before the joining step, simplifying the structure of the mold. As a result, trouble in the mold occurs less, and the maintainability for the mold can be enhanced.

In the pressing step, a protrusion protruding in the thickness direction of the second to-be-processed portion from the lateral face portion may be formed by pressing.

With the above arrangement, multiple second lid body composing members can be overlaid within a limited space for conveyance, reducing distribution costs.

The above conveying may include an industrial robot and a gripping tool mounted at a wrist portion of the industrial robot so as to grip by the gripping tool an intermediate article, which is an integration of the first lid body composing member and the second lid body composing member, so as to convey it to the pressing apparatus, and so as to put off it from the pressing apparatus after the pressing step.

The above arrangement facilitates positioning of the first lid body composing member and the second lid body composing member to predetermined positions. Further, the conveying apparatus moves the first lid body composing member and the second lid body composing member from the pressing apparatus, contemplating further labor saving in the worksite for manufacturing the lid body.

Referring to another method for manufacturing a vehicle lid body for opening/closing an opening portion formed in a vehicle, the method may include: a joining step of holding by a jig a first lid body composing member and a second lid body composing member, in which a first to-be-be-processed portion and a second to-be-processed portion are set respectively, with the first to-be-processed portion and the second to-be-processed portion overlaid with each other in a thickness direction thereof, and joining and integrating them by a joining apparatus, the first lid body composing member and the second lid body composing member being formed by stamping metal plates so as to have predetermined shapes; and a pressing step of simultaneously pressing by a pressing apparatus mounted to the jig the first to-be-processed portion and the second to-be-processed portion in a state where the jig holds the first lid body composing member and the second lid body composing member which are integrated in the joining step.

Referring to still another method for manufacturing a vehicle lid body for opening/closing an opening portion formed in a vehicle, the method may include: a primary processing step of obtaining a first lid body composing member and a second lid body composing member in which a first to-be-be-processed portion and a second to-be-processed portion are set respectively by stamping metal plates so as to have predetermined shapes, and pressing the first to-be-processed portion; a joining step of holding by a jig the first lid body composing member and the second lid body composing member, which are obtained in the primary processing step, with the first to-be-processed portion and the second to-be-processed portion overlaid with each other in the in the thickness direction thereof, and joining and integrating the first lid body composing member and the second lid body composing member by a joining apparatus; and a pressing step of pressing by a pressing apparatus mounted to the jig the second to-be-processed portion of the second lid body composing member so as to correspond to a processed trace of the first to-be-processed portion in a state where the jig holds the first lid body composing member and the second lid body composing member which are integrated in the joining step.

Referring to yet another method for manufacturing a vehicle lid body for opening/closing an opening portion formed in a vehicle, the method may include: a joining step of holding by a jig a first lid body composing member and a second lid body composing member, in which a first to-be-be-processed portion and a second to-be-processed portion are set respectively, with the first to-be-processed portion and the second to-be-processed portion overlaid with each other in the thickness direction thereof, and joining and integrating them by a joining apparatus, the first lid body composing member and the second lid body composing member being formed by stamping metal plates so as to have predetermined shapes; and a pressing step of simultaneously pressing the first to-be-processed portion and the second to-be-processed portion by a movable pressing apparatus moved by a moving apparatus in a state where the jig holds the first lid body composing member and the second lid body composing member which are integrated in the joining step.

Referring to still another method for manufacturing a vehicle lid body for opening/closing an opening portion formed in a vehicle, the method may include: a primary processing step of obtaining a first lid body composing member and a second lid body composing member in which a first to-be-be-processed portion and a second to-be-processed portion are set respectively by stamping metal plates so as to have predetermined shapes, and pressing the first to-be-processed portion; a joining step of holding by a jig the first lid body composing member and the second lid body composing member, which are obtained in the primary processing step, with the first to-be-processed portion and the second to-be-processed portion overlaid with each other in the in the thickness direction thereof, and joining and integrating them by a joining apparatus; and a pressing step of pressing by a movable pressing apparatus moved by a moving apparatus the second to-be-processed portion of the second lid body composing member so as to correspond to a processed trace of the first to-be-processed portion in a state where the jig holds the first lid body composing member and the second lid body composing member which are integrated in the joining step.

Referring to another system for manufacturing a vehicle lid body for opening/closing an opening portion formed in a vehicle, the system may include: a joining apparatus for joining and integrating a first lid body composing member and a second lid body composing member, which are formed by stamping metal plates so as to have predetermined shapes, with the first lid body composing member and the second lid body composing member overlaid with each other in the thickness direction thereof; a pressing apparatus for pressing one of a first to-be-processed portion and a second to-be-processed portion respectively set in parts where the first lid body composing member and the second lid body composing member are overlaid with each other in the thickness direction thereof so as to correspond to a processed trace formed in advance in the other to-be-processed portion; and a conveying apparatus for putting off the first lid body composing member and the second lid body composing member, which are integrated by the joining apparatus, from the joining apparatus and for conveying them to the pressing apparatus.

Referring to another system for manufacturing a vehicle lid body for opening/closing an opening portion formed in a vehicle, the system may include: a jig for holding a first lid body composing member and a second lid body composing member, which are formed by stamping metal plates so as to have predetermined shape, with the first lid body composing member and the second lid body composing member overlaid with each other in the thickness direction thereof; a joining apparatus held by the jig for joining and integrating the first lid body composing member and the second lid body composing member; and a pressing apparatus mounted to the jig for pressing one of a first to-be-processed portion and a second to-be-processed portion respectively set in parts where the first lid body composing member and the second lid body composing member are overlaid with each other in the thickness direction thereof so as to correspond to a processed trace formed in advance in the other to-be-processed portion.

Referring to still another system for manufacturing a vehicle lid body for opening/closing an opening portion formed in a vehicle, the system may include: a jig for holding a first lid body composing member and a second lid body composing member, which are formed by stamping metal plates so as to have predetermined shape, with the first lid body composing member and the second lid body composing member overlaid with each other in the thickness direction thereof; a joining apparatus held by the jig for joining and integrating the first lid body composing member and the second lid body composing member; a movable pressing apparatus for pressing one of a first to-be-processed portion and a second to-be-processed portion respectively set in parts where the first lid body composing member and the second lid body composing member are overlaid with each other in the thickness direction thereof so as to correspond to a processed trace formed in advance in the other to-be-processed portion; and a moving apparatus for moving the pressing apparatus.

According to the above inventions relating to the manufacturing system, the assembly operator is not required to put off the first lid body composing member and the second lid body composing member from the joining apparatus, to convey them to the pressing apparatus, and to set them against the pressing apparatus, thereby contemplating labor saving in the worksite for manufacturing the lid body. Further, the shape and the position of the processed trace of the first to-be-processed portion correspond to those of the processed trace of the second to-be-processed portion, suppressing occurrence of material defect to reduce man-hour for modifying the mold and the like.

### BRIEF DESCRIPTION OF THE DRAWINGS

FIG. 1 is a plan view of a manufacturing system according to Embodiment 1.

FIG. 2 is an exploded perspective view of a door.

FIG. 3 is a view showing the vicinity where a door latch mechanism of the door is mounted when viewed from a vehicle rear side.

FIG. 4 is a sectional view taken along the line A-A in FIG. 3.

FIG. 5A is a sectional view taken along the line B-B in FIG. 3 and shows a state before an inner panel and a latch mounting portion reinforcing member are joined.

FIG. 5B is a section taken along the line B-B in FIG. 3 and shows a state where the inner panel and the latch mounting portion reinforcing member are joined.

FIG. 5C is a section taken along the line B-B in FIG. 3 and shows a state where an insertion hole are formed in the inner panel and the latch mounting portion reinforcing member.

FIG. 6 is a side view of a pressing apparatus.

FIG. 7A is a sectional view taken along the line B-B in FIG. 3 and shows a state before the inner panel and the latch mounting portion reinforcing member are joined.

FIG. 7B is a section taken along the line B-B in FIG. 3 and shows a state where the inner panel and the latch mounting portion reinforcing member are joined.

FIG. 8A is a view showing a state where a processing tool moves to the inner panel and the latch mounting portion reinforcing member.

FIG. 8B is a view showing a state where the inner panel and the latch mounting portion reinforcing member are subjected to piercing.

FIG. 8C is a view showing a state where the inner panel and the latch mounting portion reinforcing member are subjected to flanging.

FIG. 9A is a partial enlarged view of FIG. 5B.

FIG. 9B is a partial enlarged view of FIG. 5C.

FIG. 10 is a view corresponding to FIG. 1 in Embodiment 2.

FIG. 11 is a view corresponding to FIG. 1 in Embodiment 3.

FIG. 12 is a side view showing a schematic construction of a pressing apparatus in Embodiment 3.

FIG. 13 is a view corresponding to FIG. 1 in Embodiment 4.

FIG. 14 is a side view showing a schematic construction of a robot and a pressing apparatus in Embodiment 4.

FIG. 15A is a partial enlarged view corresponding to FIG. 5A in Modified Example 1.

FIG. 15B is a partial enlarged view corresponding to FIG. 5B in Modified Example 1.

FIG. 15C is a partial enlarged view corresponding to FIG. 5C in Modified Example 1.

FIG. 16 is a view corresponding to FIG. 5C in Modified Example 1.

FIG. 17A is a view corresponding to FIG. 15A in Modified Example 2.

FIG. 17B is a view corresponding to FIG. 15B in Modified Example 2.

FIG. 17C is a view corresponding to FIG. 15C in Modified Example 2.

FIG. 18A is a view corresponding to FIG. 15A in Modified Example 3.

FIG. 18B is a view corresponding to FIG. 15B in Modified Example 3.

FIG. 18C is a view corresponding to FIG. 15C in Modified Example 3.

### DESCRIPTION OF THE PREFERRED EMBODIMENTS

Embodiments of the present invention will be described below with reference to the accompanying drawings. It should be noted that the preferred embodiments described below are mere substantial examples and do not intend to limit applicable articles and usage.

### Embodiment 1

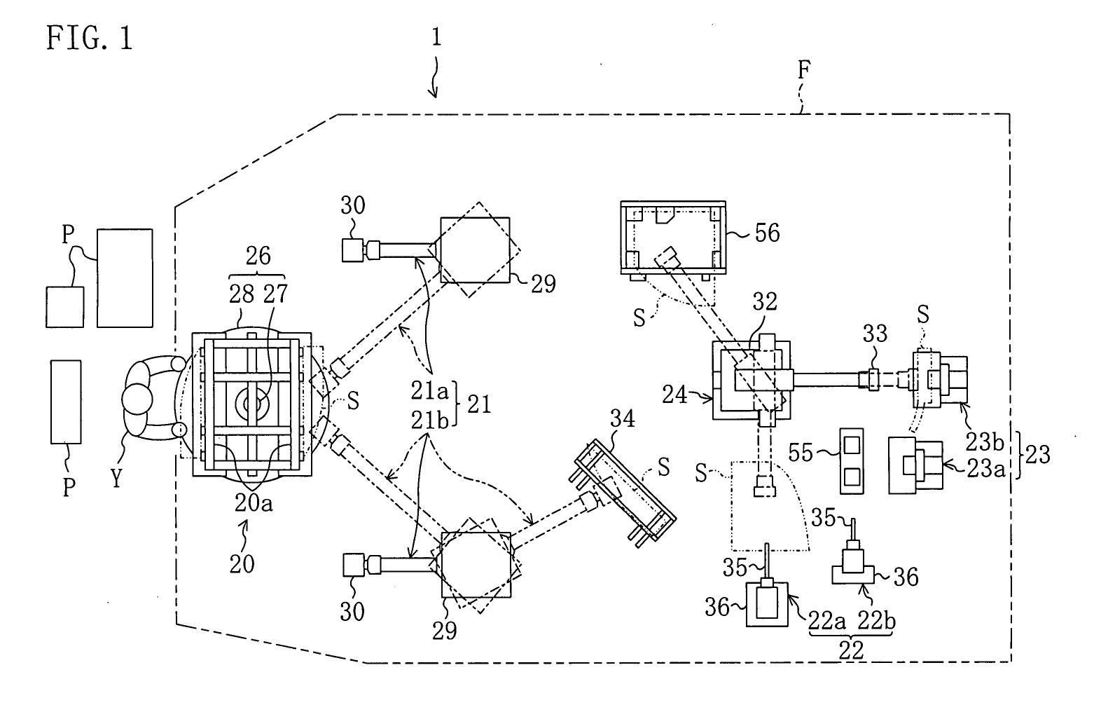

FIG. 1 shows a system 1 for manufacturing a vehicle lid body according to Embodiment 1 of the present invention. The manufacturing system 1 is installed in a factory for manufacturing a door 2 as a lid body to be arranged at a side part of an automobile (not shown).

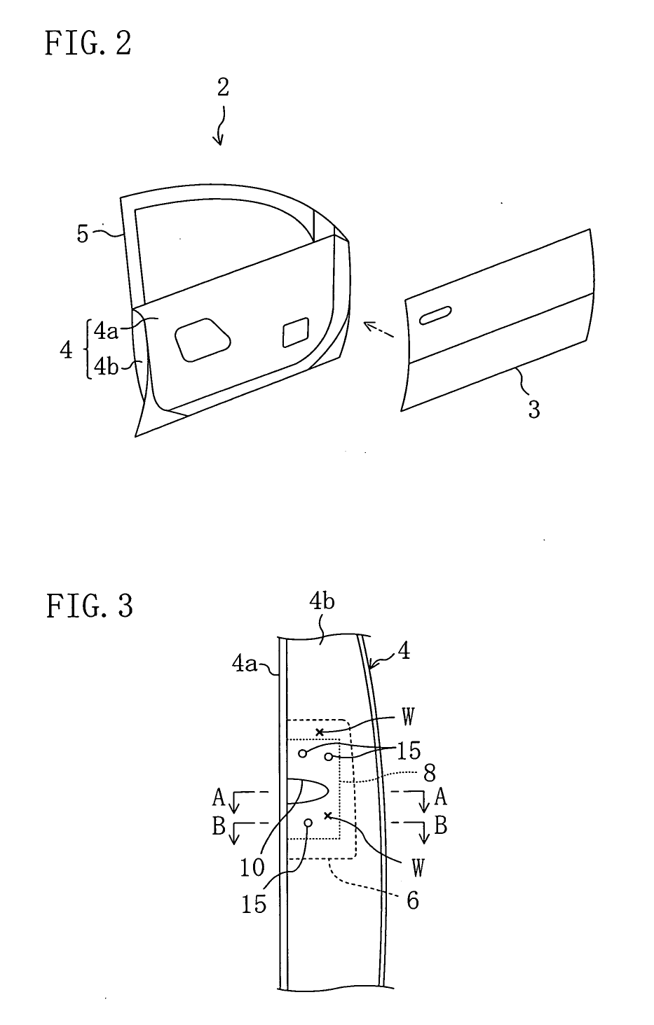

In this embodiment, a construction of the door 2 will be described before describing a construction of the manufacturing system 1. The door 2 includes, as shown in FIG. 2, an outer panel 3 composing an outboard side portion of the door 2, an inner panel 4 composing an inboard side portion, a sash 5 mounted at the upper end of the inner panel 4, a latch mounting portion reinforcing member 6 mounted on the outboard side (the outer panel 3 side) of the inner panel 4, and the like, which are to be combined and fitted to a vehicle. An inner space is formed within the door 2. These door composing members 3 to 6 are formed by stamping steel plates so as to have predetermined shapes.

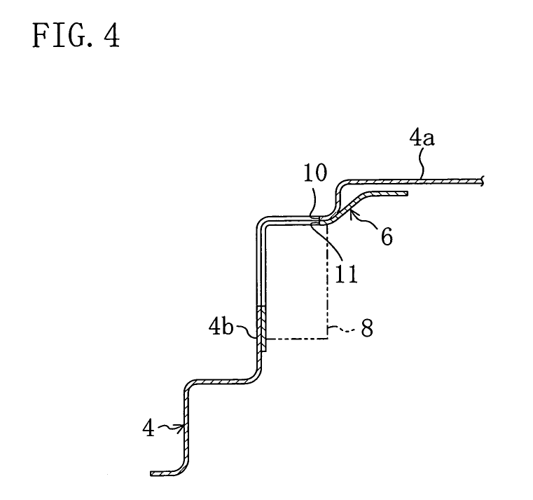

The inner panel 4 includes a body face portion 4a extending along a face where an opening of the vehicle is formed and a lateral face portion 4b extending outboard from the periphery of the body face portion 4a. As shown in FIG. 3 and FIG. 4, a door latch mechanism 8 is mounted at a boundary part of the lateral face portion 4b and the body face portion 4a which is located on a vehicle rear side of the door 2 in the inner space. The latch mounting portion reinforcing member 6 is overlaid from the outboard side with the inner panel 4 at a mounting portion to which the door latch mechanism 8 is mounted. Two parts of the latch mounting portion reinforcing member 6 which are vertically apart from each other are spot welded to the lateral face portion 4b of the inner panel 4 so that the inner panel 4 and the latch mounting portion reinforcing member 6 are integrated. In the inner panel 4 and the latch mounting portion reinforcing member 6, through holes 10, 11 are formed, respectively, for exposing the latch portion of the door latch mechanism 8. The reference W in FIG. 3 indicates each spot-welded part.

The through hole 10 of the inner panel 4 continues from the body face portion 4a to the lateral face portion 4b. A part of the through hole 10 which is formed in the body face portion 4a is formed in the process of stamping the inner panel 4. A part of the through hole 10 which is formed in the lateral face portion 4b is formed by a pressing process, which will be described later. On the other hand, the through hole 11 of the latch mounting portion reinforcing member 6 is formed in the same shape as the through hole 10 of the inner panel 4 so as to agree with the through hole 10 of the inner panel 4 when the latch mounting portion reinforcing member 6 is overlaid with the inner panel 4. The through hole 11 of the latch mounting portion reinforcing member 6 is formed in the process for stamping the latch mounting portion reinforcing member 6 simultaneously.

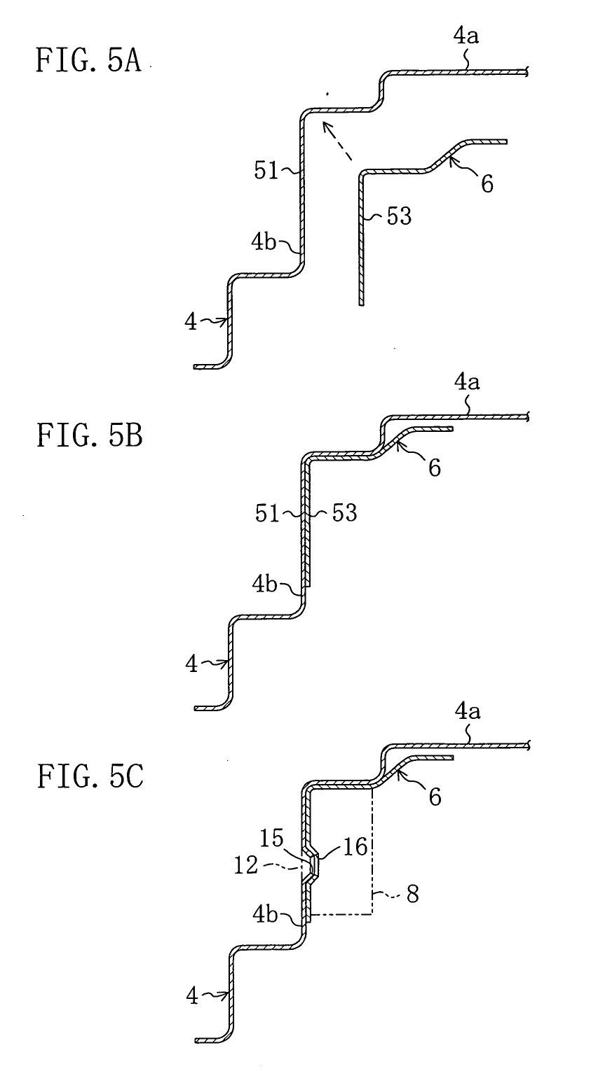

Further, insertion holes 15, 16 are formed in the inner panel 4 and the latch mounting portion reinforcing member 6, respectively, for receiving screws 12 (shown in only FIG. 5C) for fastening the door latch mechanism 8 to the inner panel 4 and the latch mounting portion reinforcing member 6. The insertion holes 15 of the inner panel 4 and the insertion holes 16 of the latch mounting portion reinforcing member 6 have the same shape and are located coaxially when the inner panel 4 and the latch mounting portion reinforcing member 6 are overlaid with each other. The peripheries of the insertion holes 15 of the inner panel 4 are flanged so as to form protrusions protruding from the lateral face portion 4b towards the inner space. The peripheries of the insertion holes 16 of the latch mounting portion reinforcing member 6 are flanged similarly. The peripheries of the respective insertion holes 15, 16 are in contact with each other entirely. The shapes of the flanged peripheries of the insertion holes 15, 16 substantially accord with the shape of the head of the screws 12.

In the present invention, the latch mounting portion reinforcing member 6 and the inner panel 4 correspond to a first lid body composing member and a second lid body composing member, respectively. Accordingly, a part where the insertion holes 16 of the latch mounting portion reinforcing member 6 are formed corresponds to a first to-be-processed portion, and a part where the insertion holes 15 and the through hole 10 in the lateral face portion 4b of the inner panel 4 are formed corresponds to a second to-be-processed portion.

The manufacturing system 1 includes, as shown in FIG. 1, a plurality of apparatuses and tools arranged in the order from the upstream side to the downstream side of a manufacturing line. The manufacturing system 1 is so arranged that the inner panel 4, the sash 5, and the latch mounting portion reinforcing member 6 are integrated and pressed to have predetermined shapes, and then, the outer panel 3 is joined to the inner panel 4 to thus obtain the door 2. Reference F in FIG. 1 indicates a fence.

Specifically, the manufacturing system 1 includes: an assembly jig 20 for holding the door composing members 4 to 6; a primary spot welding apparatus 21 for welding the door composing members 4 to 6 held by the assembly jig 20; a secondary spot welding apparatus 22 for additionally welding the door composing members 4 to 6 as an intermediate article S obtained by welding them by the primary welding apparatuses 21; a pressing apparatus 23 for pressing the intermediate article S; and a material handling robot 24 for holding and conveying the intermediate article S.

The assembly jig 20 includes at a lower part thereof a swivel 26. The swivel 26 includes a perpendicularly extending rotary shaft 27 and a rotary table 28 mounted on the rotary shaft 27. The assembly jig 20 further includes two holding members 20a, 20a fixed on the rotary table 28 symmetrically with respect to the rotary shaft 27 as a rotation center. Each holding member 20a is so arranged to position and hold the inner panel 4, the sash 5, the latch mounting portion reinforcing member 6, and the like in a state where they are capable of being joined.

The primary spot welding apparatus 21 includes two primary spot welding apparatuses 21a, 21b arranged on the downstream side of the assembly jig 20 in the manufacturing line. The primary spot welding apparatuses 21a, 21b are known apparatuses generally employed for steel plate spot welding in worksites for manufacturing a door and the like, and each are so composed that a spot welder 30 is mounted to an industrial robot 29. The primary spot welding apparatuses 21a, 21b are provided for welding one side and the other side in the longitudinal direction of the door composing members 4 to 6, respectively.

A material handle (not shown) for gripping the intermediate article S is mounted to the robot 29 of one 21b of the primary spot welding apparatuses 21a, 21b. This primary spot welding apparatus 21b puts off the intermediate article S from the assembly jig 20 and conveys it to the downstream side of the manufacturing line.

The material handling robot 24 is arranged on the downstream side of the primary spot welding apparatus 21 in the manufacturing line. The material handling robot 24 is a known robot generally employed in the worksites for manufacturing an automobile and the like, and includes an industrial robot 32 and a material handle 33 mounted at the rest of the industrial robot 32.

Between the primary spot welding apparatus 21 and the material handling robot 24, a first temporary placing table 34 is provide on which the intermediate article S which the material handle of the spot welding apparatus 21b grips and conveys is to be placed temporally.

On the downstream side of the first temporary placing table 34 in the manufacturing line, two second spot welding apparatuses 22a, 22b of the secondary spot welding apparatus 22 are arranged side by side along the flow of the manufacturing line. In each of the upstream and downstream secondary spot welding apparatuses 22a, 22b in the manufacturing line, a spot welder 35 is fixed to a base table 36. The secondary spot welding apparatus 22 is provided for performing full welding of a to-be-welded portion other than the part welded by the primary spot welding apparatus 21 so that the joining strength among the door composing members 4 to 6 is ensured.

The reason why the two secondary spot welding apparatuses 22a, 22b are provided as above is that plural kinds of doors, for example, a front door to be provided in the front of a vehicle and a rear door to be provided in the rear thereof can be manufactured in this manufacturing system 1. In detail, for example, an intermediate article S of the front door is welded by one 22a of the secondary spot welding apparatuses 21a, 22b located on the upstream side in the manufacturing line, and an intermediate article S of a rear door is welded by the other secondary spot welding apparatus 22b located on the downstream side thereon. It is noted that only one secondary spot welding apparatus may be provided or three or more may be provided. Further, the manufacturing system 1 may manufacture a left door to be arranged on the left of the vehicle and a right door to be arranged on the right thereof.

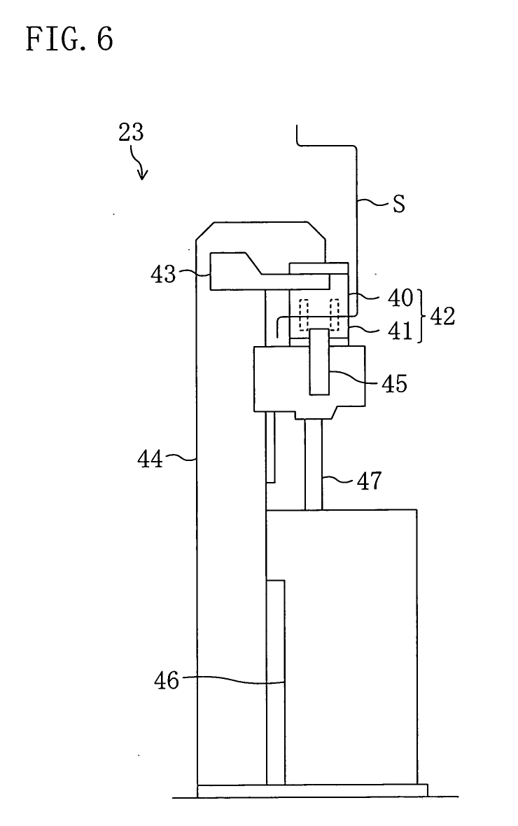

On the downstream side of the secondary spot welding apparatus 22, two pressing apparatuses 23a, 23b of the pressing apparatus 23 are arranged side by side along the flow of the manufacturing line. Each of the pressing apparatuses 23a, 23b includes, as shown in FIG. 6, a mold 42 composed of an upper die 40 and a lower die 41, an upper die support mechanism 43, a column member 44, a lower die support mechanism 45, and a vertically contracting/extending hydraulic cylinder 46. The upper die 40 is supported at the upper end of the column member 44 by the upper die support mechanism 43. The lower die 41 is supported by the lower die support mechanism 45.

The upper die support mechanism 43 is driven by an actuator (not shown) for changing the position of the upper die 40 between a position where it is held at the upper end of the column member 44 and a position where it is separated from the upper end of the column member 44. A positioning pin (not shown) protruding downward is provided at the upper end portion of the column member 44 while a hole (not shown) in which the positioning pin is to be inserted is formed in the upper face portion of the upper die 40. When the positioning pin is inserted in the hole of the upper die 40, the upper die 40 is positioned at a predetermined position.

On the other hand, the lower die support mechanism 45 is mounted at the upper end of a rod 47 of the hydraulic cylinder 46 so that the lower die 41 moves to and away from the upper die 40 according to the operation of the hydraulic cylinder 46. A positioning pin (not shown) protruding upward is provided at the upper end of the rod 47 while a hole (not shown) in which the positioning pin is to be inserted is formed in the lower face portion of the lower die 41. When the positioning pin is inserted in the hole of the lower die 41, the lower die 41 is positioned at a predetermined position. The lower die support mechanism 45 is driven by an actuator (not shown), similarly to the upper die support mechanism 43, for changing the position of the lower die 41 between a position where it is held at the upper end of the rod 47 and a position where it is separated from the upper end of the rod 47.

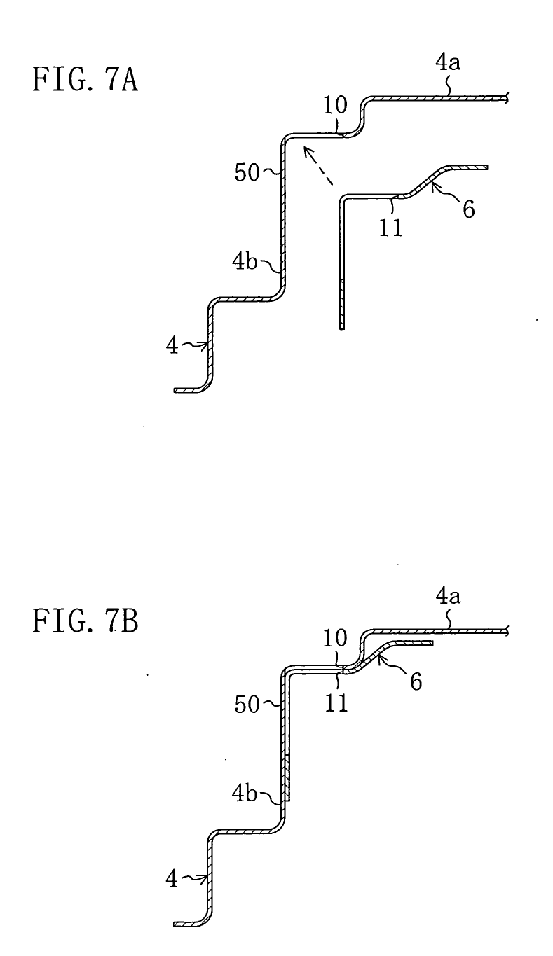

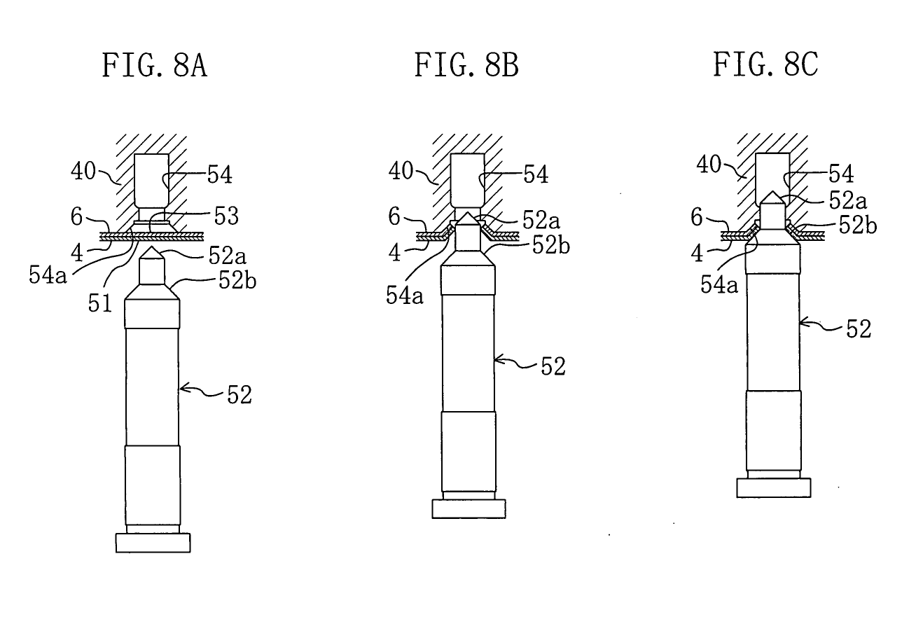

To the lower die 41, there is mounted a through hole processing tool (not shown) for forming the through hole 10 by piercing as a pressing process a to-be-processed portion 50 (shown in FIG. 7) where the through hole 10 is to be formed in the inner panel 4. There is further mounted to the lower die 41 an insertion hole processing tool 52 for forming the insertion holes 15 by piercing a to-be-processed portion 51 (shown in FIG. 5 and FIG. 8) where the insertion holes 15 are to be formed in the inner panel 4 and for flanging as a pressing process the peripheries of the insertion holes 15. The insertion holes 16 are formed in a to-be-processed portion 53 (shown in FIG. 5 and FIG. 8) of the latch mounting portion reinforcing member 6 by the insertion hole processing tool 52.

The insertion hole processing tool 52 is formed in a bar-like shape extending vertically, as shown in FIG. 8, and is fixed at the lower end thereof to the lower die 41. A piercing section 52a is formed at the upper end of the insertion hole processing tool 52 while a flanging section 52b is formed at the lower end thereof. The piercing section 52a is in a tapered column shape while the flanging section 52b has a tapered face continuing to the lower end of the piercing section 52a and extending downward with its diameter increased.

In the upper die 40, there are formed a first hole (not shown) for relieving the through hole processing tool when the upper die 40 and the lower die 41 approach each other and a second hole 54 for relieving the insertion hole processing tool 52 at that time. A tapered face 54a is formed at the periphery of the second hole 54 so as to correspond to the flanging section 52b of the insertion hole processing tool 52 so that the intermediate article S is flanged along this tapered face 54a and the tapered face 52b of the insertion hole processing tool 52.

The material handling robot 24 interchanges the upper die 40 and the lower die 41. In the case, for example, where the positions or the shapes of the insertion holes 15, 16 are different between the front door and the rear door respectively arranged in the front and the rear sides of the vehicle, a mold for the front door and a mold for the rear door are prepared, and a mold not supported to the pressing apparatus 23 is placed on a mold placing table 55 provided near the material handling robot 24, as shown in FIG. 1. There may be provided three or more kinds of molds.

On the downstream side of the pressing apparatus 23 in the manufacturing line, a second temporary placing table 56 is provided on which the intermediate article S pressed by the pressing apparatus 23 is to be placed temporally. Though not shown, the outer panel 3 is mounted by another apparatus to the intermediate article S integrated as above as an integration of the inner panel 4, the sash 5, and the latch mounting portion reinforcing member 6, thereby obtaining the door 2.

Next, description will be given to a method for manufacturing the door 2 with the use of the thus constructed manufacturing system 1. First, the inner panel 4, the sash 5, and the latch mounting portion reinforcing member 6 are formed by stamping using stamping apparatuses (not shown) installed apart from the manufacturing system 1. This process corresponds to a primary processing step in the present invention. In this stamping, a part of the through hole 10 which is formed in the body face portion 4a of the inner panel 4 is formed simultaneously with formation of the body face portion 4a and the lateral face portion 4b. A mold of the stamping apparatus for stamping the inner panel 4 in the primary processing step has no cam die for forming the insertion holes 15 and a part of the through hole 10 which is formed in the lateral face portion 4b. Accordingly, in the primary processing step, the through hole 10 and the insertion holes 15 are not formed in the lateral face portion 4b. Also, no structure for forming the insertion holes 16 is included in a mold for stamping the latch mounting portion reinforcing member 6, and accordingly, the insertion holes 16 are not formed in the latch mounting portion reinforcing member 6 in the primary processing step.

The inner panel 4, the sash 5, and the latch mounting portion reinforcing member 6 thus formed are conveyed to places near the assembly jig 20 in a state where they are placed on respective pallets P. In this state, the insertion holes 15 are not formed in the lateral face portion 4b of the inner panel 4, and therefore, the lateral face portion 4b is not subjected to flanging, as shown in FIG. 5A, and has no protrusion in the thickness direction at the to-be-processed portion 51 for the insertion holes. Accordingly, a phenomenon that the protrusion obstructs conveyance of the inner panel 4 is prevented, and a multiplicity of inner panels 4 can be overlaid within a limited space of a pallet P for conveyance. Further, even if the lateral face portions 4b of the overlaid inner panels 4 are in contact with each other in conveyance, flaws such as an indentation and the like are hardly formed at the lateral face portion 4b with no protrusion formed at the to-be-processed portion 51 for insertion holes. This eliminates the need to interpose a cushion material between the inner panels 4 for conveyance, enabling multiple inner panels 4 to be overlaid within a limited space for conveyance, as well. Similarly, the latch mounting portion reinforcing member 6 has no insertion holes 16 and is not subjected to flanging, which means no protrusion protruding in the thickness direction of the latch mounting portion reinforcing member 6 formed in the to-be-processed portion 53 of the latch mounting portion reinforcing member 6. Accordingly, multiple latch mounting portion reinforcing members 6 can be overlaid within a limited space for conveyance.

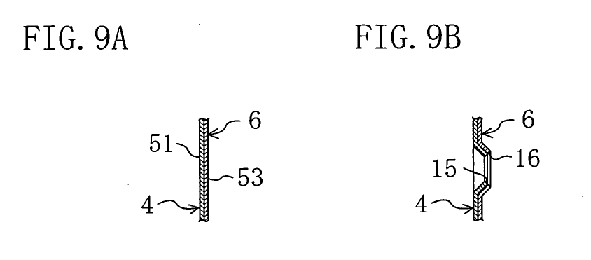

Subsequently, as shown in FIG. 1, an assembly operator Y makes one 20a of the holding members located at the side opposite the primary spot welding apparatus 21 to hold the inner panel 4, the sash 5, and the latch mounting portion reinforcing member 6 placed on the respective pallets P. The holding member 21a holds them so that the to-be-processed portion 51 of the inner panel 4 and the to-be-processed portion 53 of the latch mounting portion reinforcing member 6 are overlaid with each other in the thickness direction thereof, as shown in FIG. 5B and FIG. 9A, and the to-be-processed portion 50 of the inner panel 4 and the through hole 11 of the latch mounting portion reinforcing member 6 are overlaid with each other, as shown in FIG. 7B.

Thereafter, the holding member 20a holding the inner panel 4, the sash 5, and the latch mounting portion reinforcing member 6 is rotated at 180 degrees by the swivel 26 so as to face the primary spot welding apparatus 21. The inner panel 4, the sash 5, and the latch mounting portion reinforcing member 6 held by the holding member 20a are integrated by welding by the primary spot welding apparatus 21, thereby obtaining an intermediate article S.

Next, as shown by virtual lines in FIG. 1, one 21b of the spot welding apparatus holds by its material handle the intermediate article S held by the assembly jig 20, puts off it from the holding member 20, conveys it to the first temporary placing table 34, and then places it on the first temporary placing table 34. The material handling robot 24 grips and holds up the intermediate article S placed on the first temporary placing table 34, conveys it to the secondary spot welding apparatus 22a or 22b, and sets a to-be-welded portion of the intermediate article S against the spot welder 35 thereof so that the to-be-welded portion is welded by the spot welder 35 thereof. In this way, the intermediate article S is conveyed by the material handling robot 24, and plural to-be-welded portions are welded by the spot welder 35 of the secondary spot welding apparatus 22 sequentially, thereby completing welding of the door composing members 4 to 6. In the present invention, the first spot welding apparatus 21 and the secondary spot welding apparatus 22 correspond to a joining apparatus, and welding performed by the spot welding apparatuses 21, 22 corresponds to a joining step.

After completion of the joining step, the material handling robot 24 puts off the intermediate article S from the secondary spot welding apparatus 22 while holding the intermediate article S, conveys it to the pressing the pressing apparatus 23, and sets it against the pressing apparatus 23. As a result, as shown in FIG. 8A and FIG. 9B, the to-be-processed portions 50, 51, 53 of the intermediate article S are located between the upper die 40 and the lower die 41. In the present invention, the material handling robot 24 corresponds to a conveying apparatus, and the operation for setting the intermediate article S against the pressing apparatus 23 by the material handling robot 24 corresponds to a setting step. In the setting step, when the material handle 33 is positioned, the intermediate article S is set at a predetermined position against the mold 42.

Following completion of the setting step, the hydraulic cylinder 46 is activated to raise the lower die 41. The lower die 41 moves to the upper die 40 accordingly, so that the insertion holes 15, 16 are formed in the to-be-processed portion 51 for insertion holes of the inner panel 4 and the to-be-processed portion 53 for insertion holes of the latch mounting portion reinforcing member 6, respectively, by the insertion hole processing tool 52, as shown in FIG. 8A, while each periphery of the insertion holes 15, 16 is flanged by the flanging section 52b and the tapered face 54a, as shown in FIG. 8C. Further, though not shown, the through hole 10 is formed in the to-be-processed portion 50 of the inner panel 4 by the insertion hole processing tool. The above process corresponds to a pressing step of the present invention.

In the pressing step, the to-be-processed portion 51 for insertion holes of the inner panel 4 and the to-be-processed portion 53 for insertion holes of the latch mounting portion reinforcing member 6 are overlaid with each other when viewed in a direction where the insertion hole processing tool 52 moves, so that insertion holes 15, 16 are formed simultaneously in the to-be-processed portions 51, 53, respectively, by the piercing section 52a of the insertion hole processing tool 52. Further, a flanged part protruding towards the inner space is formed at each periphery of the insertion holes 15, 16 of the to-be-processed portions 51, 53 by the flanging section 52b of the insertion hole processing tool 52.

Thus, the to-be-processed portion 51 of the inner panel 4 and the to-be-processed portion 53 of the latch mounting portion reinforcing member 6 are subjected to the same pressing simultaneously, so that the shapes and the positions of the insertion holes 15 of the inner panel 4 correspond to the shapes and the positions of the insertion holes 16 of the latch mounting portion reinforcing member 6 even if error occurs at stamping the inner panel 4 or the latch mounting portion reinforcing member 6 or even if a joint part of the inner panel 4 and the latch mounting portion reinforcing member 6 is displaced from a predetermined position, suppressing occurrence of material defect.

The to-be-processed portion 50 for through hole of the inner panel 4 and the through hole 11 of the latch mounting portion reinforcing member 6 are overlaid with each other when viewed in the direction where the through hole processing tool moves. Accordingly, the through hole processing tool can press the to-be-processed portion 50 so that the to-be-processed potion 50 have a shape corresponding to the shape of the through hole 11. Hence, the shape and the position of the through hole 10 of the inner panel 4 correspond to the shape and the position of the through hole 11 of the latch mounting portion reinforcing member 6 even if error occurs at stamping the inner panel 4 or the latch mounting portion reinforcing member 6 or even if a joint part of the inner panel 4 and the latch mounting portion reinforcing member 6 is displaced from a predetermined position, suppressing occurrence of material defect, as well.

Following completion of the pressing step, the material handling robot 24 puts off the intermediate article S from the pressing apparatus 23 while holding the intermediate article S, and puts it on the second temporary placing table 56. The intermediate article S placed on the second temporary placing table 56 is conveyed to another place and is integrated with the outer panel 3, thereby forming the door 2.

As described above, in the manufacturing system 1 and the manufacturing method according to Embodiment 1, the material handling robot 24 conveys automatically to the pressing apparatus 23 the intermediate article S, which is an integration of the door composing members 4 to 6 by the primary spot welding apparatus 21 and the secondary spot welding apparatus 22, reducing man-hour for the assembly operator Y in the worksite to lead to labor saving. Further, both the to-be-processed portions 51, 53 of the inner panel 4 and the latch mounting portion reinforcing member 6 which are integrated are pressed simultaneously, and the to-be-processed portion 50 of the latch mounting portion reinforcing member 6 is pressed by the through hole processing tool so as to correspond to the shape of the through hole 10 of the inner panel 4. This suppresses occurrence of material defect and reduces man-hour for modifying the mold 42 and the like.

Moreover, the to-be-processed portion 51 in the lateral face portion 4b may be subjected to piercing and flanging after the body face portion 4a and the lateral face portion 4b of the inner panel 4 are formed by stamping in the primary processing step prior thereto. This simplifies the structure of the mold for stamping the inner panel 4 in the primary processing step. As a result, trouble occurring in the mold can be lessened, and the maintainability for the mold can be increased.

Furthermore, the lateral face portion 4b of the inner panel 4 and the latch mounting portion reinforcing member 6 are subjected to flanging in the pressing step, and therefore, the lateral face portion 4b of the inner panel 4 and the latch mounting portion reinforcing member 6 have no protrusions by flanging in conveyance thereof with the pallet P. With no protrusion presenting an obstacle, plural inner panels 4 and plural latch mounting portion reinforcing members 6 can be overlaid within limited spaces for conveyance, reducing distribution costs.

In addition, the material handling robot 24 conveys the intermediate article S, facilitating positioning of the intermediate article S to a predetermined position in the pressing apparatus 23. Further, the material handling robot 24 puts off the intermediate article S from the pressing apparatus 23 after completion of the pressing step, so that further labor saving can be contemplated in the worksite.

### Embodiment 2

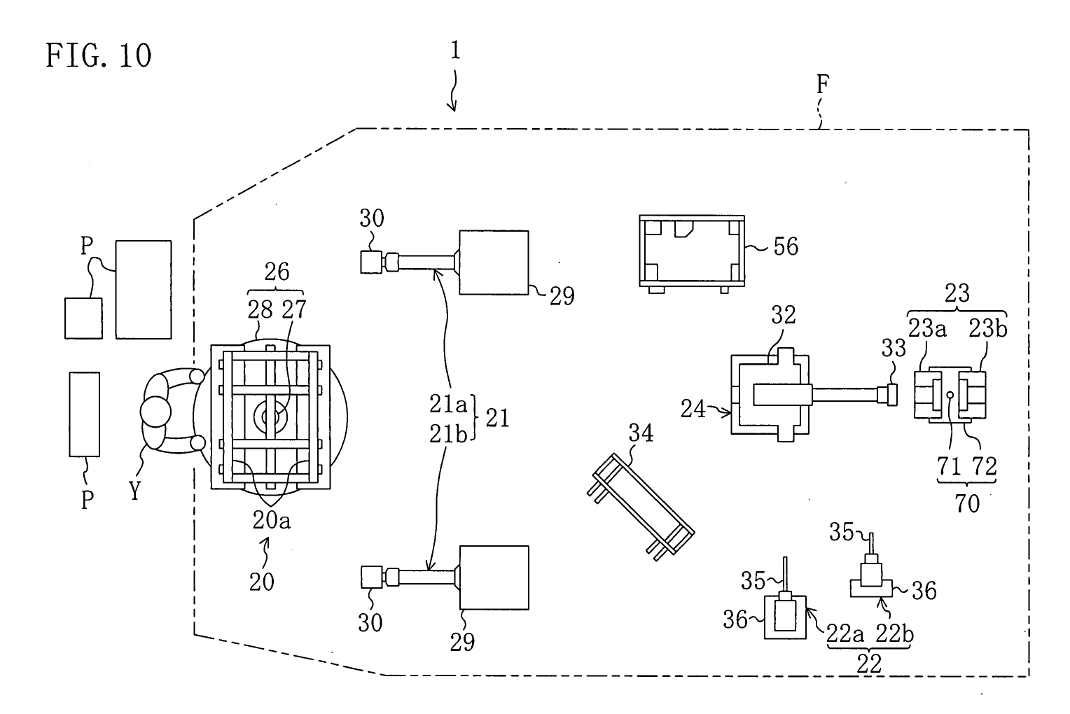

FIG. 10 shows a manufacturing system 1 according to Embodiment 2 of the present invention. The manufacturing system 1 in Embodiment 2 is the same as the manufacturing system 1 in Embodiment 1, except the position of the pressing apparatus 23. Therefore, the same reference numerals are assigned to the same elements as those in Embodiment 1, and only a different point therefrom will be described below.

In the present embodiment, the pressing apparatus 23 includes two pressing apparatus 23a, 23b provided on a swivel 70. The swivel 70 includes a rotary shaft 71 and a rotary table 72, similarly to the swivel 26. The pressing apparatuses 23a, 23b are fixed on the rotary table 72 symmetrically with the rotary shaft 71 interposed as a rotation center. When one 23a of the pressing apparatuses is arranged on the material handling robot 24 side, and a mold for, for example, the front door is supported thereto, the intermediate article S can be pressed to by the pressing apparatus 23a. During this pressing, the other pressing apparatus 23b is located on the side opposite the material handling robot 24 so that the assembly operator Y can easily interchange a mold for the other pressing apparatus 23b. When the rotary table 72 is rotated at 180 degrees so that the other pressing apparatus 23b is positioned on the material handling robot 24 side, an intermediate article S of another type can be pressed by the other pressing apparatus 23b. This enables mold interchange with no flow of the manufacturing line stopped. In the manufacturing system 1 and the manufacturing method according to Embodiment 2, labor saving in the worksite can be contemplated, and occurrence of material defect can be suppressed, reducing man-hour for modifying the mold 42 and the like, similarly to Embodiment 1.

### Embodiment 3

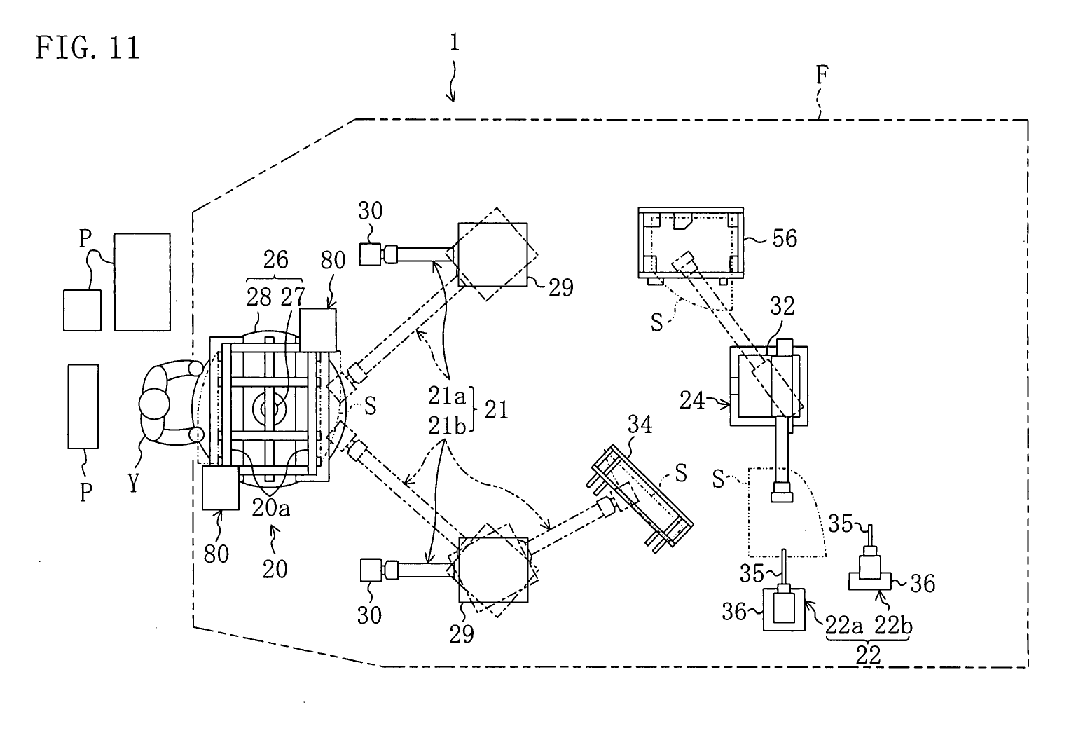

FIG. 11 shows a manufacturing system 1 according to Embodiment 3 of the present invention. The manufacturing system 1 in Embodiment 3 is the same as the manufacturing system 1 in Embodiment 1, except the pressing apparatus. Therefore, the same reference numerals are assigned to the same elements as those in Embodiment 1, and only a different point therefrom will be described below.

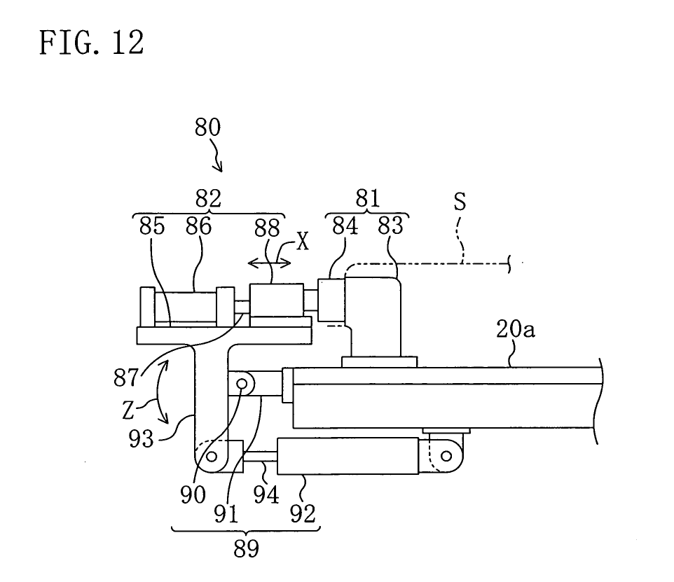

In the present embodiment, two pressing apparatuses 80, 80 are provided symmetrically with the rotary shaft 27 of the assembly jig 20 interposed as a rotation center and are fixed to the holding members 20a, 20a, respectively. Each pressing apparatus 80 includes, as shown in FIG. 12, a mold 81 and a drive mechanism 82 for driving the mold 81. The mold 81 includes a fixed die 83 fixed to a part of the holding member 20a where the inner panel 4 and the like are held and a movable die 84 capable of horizontally moving to and away from the fixed die 83. A piercing and flanging tool (not shown) is mounted to the movable die 84.

The drive mechanism 82 includes a support table 85, a first hydraulic cylinder 86 fixed to the support table 85, and a guide member 88 for guiding a rod 87 of the first hydraulic cylinder 86. The rod 87 of the first hydraulic cylinder 86 extends and contracts in the direction (indicted by an arrow X in FIG. 12) moving to and away from the fixed die 83. The first hydraulic cylinder 86 operates the movable die 84 so that the movable die 84 moves to or away from the fixed die 83. The to-be-processed portions 50, 51, 53 are overlaid with the molding face of the fixed die 83 in a state where the corresponding holding member 20a holds the inner panel 4 and the latch mounting portion reinforcing member 6.

The support table 85 is supported to the holding members 20a by a rotation mechanism 89. The rotation mechanism 89 includes a support shaft 90, a fixing member 91 for fixing the support shaft 90 to the outer peripheral face of the holding member 20a, and a second hydraulic cylinder 92. The hydraulic cylinder 92 is mounted to the holding member 20a at the side opposite the fixed die 83. The support table 85 includes a protruding portion 93 protruding towards the second hydraulic cylinder 92. The support shaft 90 is connected to an intermediate part in the longitudinal direction of the protruding portion 93. A rod 94 of the second hydraulic cylinder 92 extends and contracts inwardly and outwardly of the holding member 20a and is connected at the tip end thereof to the tip end of the protruding portion 93 of the support table 85. Accordingly, when the second hydraulic cylinder 92 operates the support table 85, the support table 85 rotates around the support shaft 90 (indicated by an arrow Z in FIG. 12) for moving the first hydraulic cylinder 86, the guide member 88, and the movable die 84.

The first hydraulic cylinder 86 and the second hydraulic cylinder 92 are controlled by a hydraulic cylinder controller (not shown). The controller receives a welding completion signal from at least a controller for the primary spot welding apparatus 21.

In order to manufacture the door 2 with the use of the manufacturing system 1, the assembly operator Y first makes one of the holding member 20a to hold the inner panel 4, the sash 5, and the latch mounting portion reinforcing member 6 which are stamped in the primary processing step. Then, the primary spot welding apparatus 21 welds the inner panel 4, the sash 5, and the latch mounting portion reinforcing member 6 to obtain an intermediate article S. This process corresponds to the joining step.

Subsequently, a welding completion signal output from the controller for the primary spot welding apparatus 21 is input to the controller for the hydraulic cylinders 86, 92. On the basis of the input signal, the controller for the hydraulic cylinders 86, 92 operates first the second hydraulic cylinder 92 for extending the rod 94 so that the movable die 84 and the drive mechanism 82 which are located at a withdrawal position are moved to a position allowing pressing. Next, the controller for the hydraulic cylinders 86, 92 operates the first hydraulic cylinder 86 for moving the movable die 84 so that the to-be-processed portions 50, 51, 53 are pressed in a state where the assembly jig 20 holds the inner panel 4 and the latch mounting portion reinforcing member 6. This process corresponds to the pressing step. After the pressing step, welding is performed by the secondary spot welding apparatus 22.

In short, in Embodiment 3, the to-be-processed portions 50, 51, 53 can be pressed simultaneously by one of the pressing apparatuses 80 mounted to the assembly jig 20 in a state where the assembly jig 20 holds the inner panel 4 and the latch mounting portion reinforcing member 6.

In the manufacturing system 1 and the manufacturing method according to Embodiment 3, similarly to Embodiment 1, labor saving in the worksite can be contemplated, and occurrence of material defect can be suppressed, reducing man-hour for modifying the mold 81 and the like.

Further, the pressing apparatuses 80 are mounted to the assembly jig 20, eliminating the need of the setting step as in Embodiments 1 and 2.

In Embodiment 3, the inner panel 4 is held by one of the holding members 20a with the open side of the inner panel 4 facing the holding member 20a for obtaining the intermediate article S. It is noted, however, that the present invention is not limited thereto and that the holding member 20a may be allowed to hold the inner panel 4 with the side opposite the open side of the inner panel 4 facing the holding member 20a for obtaining the intermediate article S.

### Embodiment 4

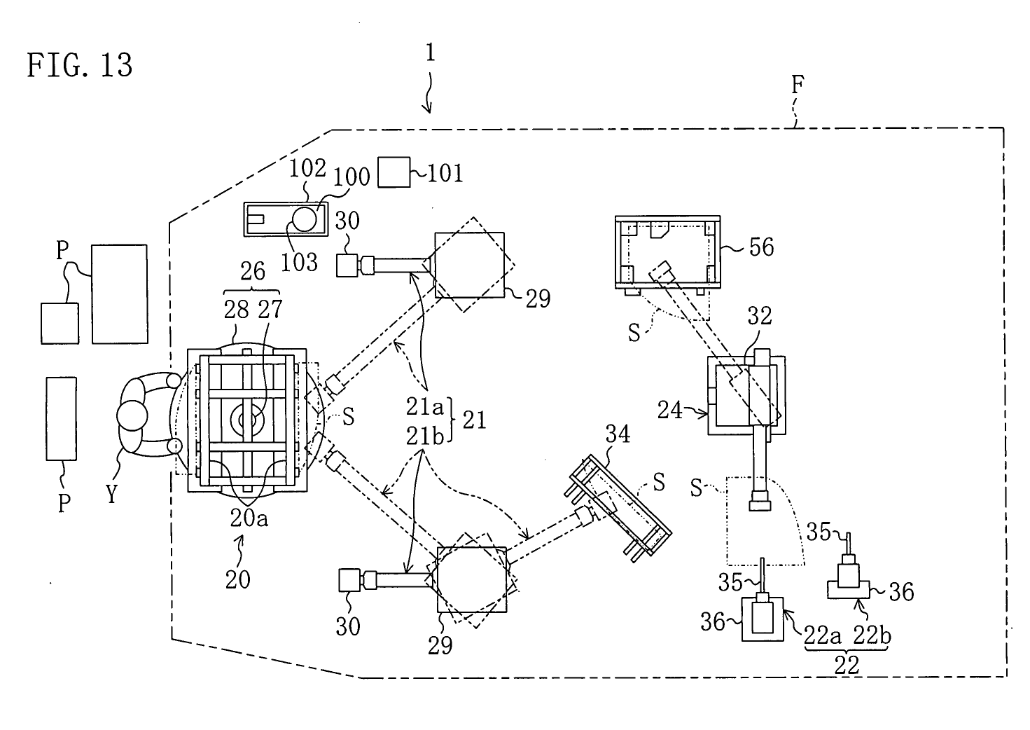

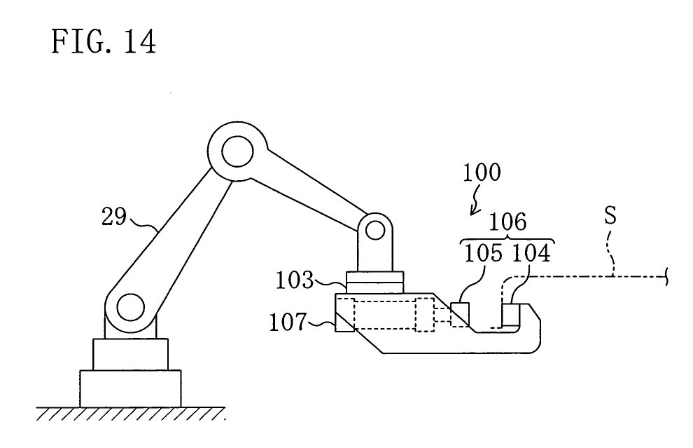

FIG. 13 shows a manufacturing system 1 according to Embodiment 4 of the present invention. The manufacturing system 1 in Embodiment 4 is the same as the manufacturing system 1 in Embodiment 1, except the pressing apparatus. Therefore, the same reference numerals are assigned to the same elements as those in Embodiment 1, and only a different point therefrom will be described below.

In the present embodiment, a movable pressing apparatus 100 is moved by the robot 29 as moving means and then performs pressing. There are provided near the robot 29 a first placing table 101 on which the spot welder 30 is to be put and a second placing table 102 on which a pressing apparatus 100 is to be put. The spot welder 30 and the pressing apparatus 100 are mounted to the robot 29 interchangeably by an ATC (automatic tool changer) 103.

The pressing apparatus 100 includes a mold 106 composed of a fixed die 104 and a movable die 105, similarly to Embodiment 3, and a hydraulic drive unit 107 for driving the movable die 105. A piercing and flanging tool (not shown) is mounted to the movable die 105. The hydraulic drive unit 107 is a general one conventionally employed as a drive source in various fields and is formed small by integrating a servo motor, a hydraulic pump, and the like (not shown). The movable die 105 is moved to and away from the fixed die 104 according to the oil pressure generated by the hydraulic pump of the hydraulic drive unit 107.

In order to manufacture the door 2 with the use of the manufacturing system 1, the assembly operator Y first makes one of the holding members 20a to hold the inner panel 4, the sash 50, and the latch mounting-portion reinforcing member 6 which are stamped in the primary processing step. Then, the robot 29 to which the spot welder 30 is mounted welds the inner panel 4, the sash 5, and the latch mounting portion reinforcing member 6, thereby obtaining the intermediate article S. This process corresponds to the joining step.

Subsequently, the spot welder 30 mounted to the robot 29 is interchanged with the pressing apparatus 100 by the ATC 103. The robot 29 then moves the pressing apparatus 100, and the pressing apparatus 100 presses the to-be-processed portions 50, 51 in the state where the assembly jig 20 holds the inner panel 4 and the latch mounting portion reinforcing member 6.

In sum, in Embodiment 4, the pressing apparatus 100 moved by the robot 29 can presses the to-be-processed portions 50, 51, 53 in the state where the assembly jig 20 holds the inner panel 4 and the latch mounting portion reinforcing member 6. This process corresponds to the pressing step. After the pressing step, welding is performed by the secondary spot welding apparatus 22.

The manufacturing system 1 and the manufacturing method according to Embodiment 4 can contemplate labor saving in the worksite, similarly to Embodiment 1. Further, material defect can be suppressed, reducing man-hour for modifying the mold 42 and the like.

Further, the pressing apparatus 100 can be moved by the robot 29, eliminating the need of the setting step in Embodiment 1 or 2.

Moreover, the robot 29 moves the pressing apparatus 100, which enables the single mold 106 to press different parts of the door 2. Further, the single pressing apparatus 100 can cope with doors having different shapes according to the types of automobiles with no interchange of the mold 106 necessitated, resulting in reduction in cost of installation.

In Embodiment 4, a plurality of pressing apparatuses including exclusive molds for respective vehicle types may be prepared and be interchanged by the ATC 103. With this arrangement, in the case where a plurality of to-be-processed portions are close to each other, for example, man-hour can be reduced by using a mold capable of processing the to-be-processed portions at one time.

It is noted that to-be-processed portions may be set to door composing members other than the inner panel 4 and the latch mounting portion reinforcing member 6 for processing the to-be-processed portions in the pressing step. Further, other to-be-processed portions may be set to the door composing members so as to be subjected to a pressing process such as embossing for forming protrusions and depressions, notching for forming a notch, or the like in the pressing step, other than the piercing and flanging.

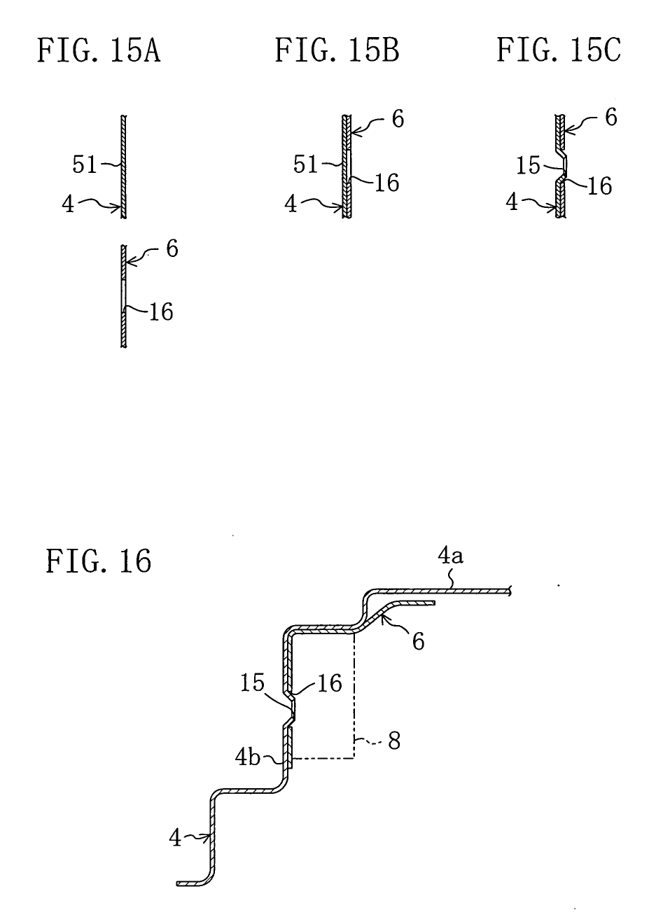

Furthermore, in the above embodiments, the to-be processed portion 51 for insertion holes of the inner panel 4 and the to-be-processed portion 53 for insertion holes of the latch mounting portion reinforcing member 6 are pressed simultaneously. However, only one of the to-be-processed portions may be pressed to have a predetermined shape in the primary processing step so that the other to-be-processed portion is pressed so as to have a shape corresponding to the processed trace of the one to-be-processed portion in the pressing step thereafter. Specifically, as in Modified Example 1 shown in FIG. 15 and FIG. 16, the insertion holes 16 are formed in the to-be-processed portion 53 of the latch mounting portion reinforcing member 6 before the pressing step (see FIG. 15A and FIG. 15B). Then in the pressing step, the insertion holes 15 smaller than the insertion holes 16 of the latch mounting portion reinforcing member 6 are formed in the to-be-processed portion 51 for insertion holes of the inner panel 4, and the peripheries of the thus formed insertion holes 15 of the inner panel 4 are flanged so as to have a shape corresponding to the insertion holes 16 of the latch mounting portion reinforcing member 6 (see FIG. 15C and FIG. 16).

In order to press the to-be-processed portion 51 of the inner panel 4 in the pressing step so that the to-be-processed portion 51 has a shape corresponding to the processed trace of the to-be-processed portion 53 of the latch mounting portion reinforcing member 6 as above, the pressing apparatus 23 presses the to-be-processed portion 51 of the inner panel 4 overlaid with the processed trace of the to-be-processed portion 53 of the latch mounting portion reinforcing member 6 which is formed in integrating the inner panel 4 and the latch mounting portion reinforcing member 6, so that the to-be-processed portion 51 have a shape corresponding to the insertion holes 16 in the to-be-processed portion 53 of the latch mounting portion reinforcing member 6. Whereby, the shape and the position of the insertion holes 15 of the inner panel 4 correspond to the shape and the position of the insertion holes 16 of the latch mounting portion reinforcing member 6

In order to press the to-be-processed portion 51 of the inner panel 4 in the pressing step so that the to-be-processed portion 51 has a shape corresponding to the processed trace of the to-be-processed portion 53 of the latch mounting portion reinforcing member 6, the body face portion 4a and the lateral face portion 4b may be formed by stamping the inner panel 4 in the primary processing step so that the to-be-processed portion 51 in the lateral face portion 4b is subjected to piercing and flanging in the pressing step thereafter. This simplifies the structure of the mold for stamping the inner panel 4 in the primary processing step, lessening occurrence of trouble in the mold and enhancing the maintainability for the mold.

In Modified Example 1, the lateral face portion 4b of the inner panel 4 is subjected to flanging in the pressing step, as well, so that the lateral face portion 4b has no flanged protrusion in conveying the inner panel 4 placed on the pallet p. Accordingly, multiple inner panels 4 can be overlaid within a limited space for conveyance, reducing distribution costs.

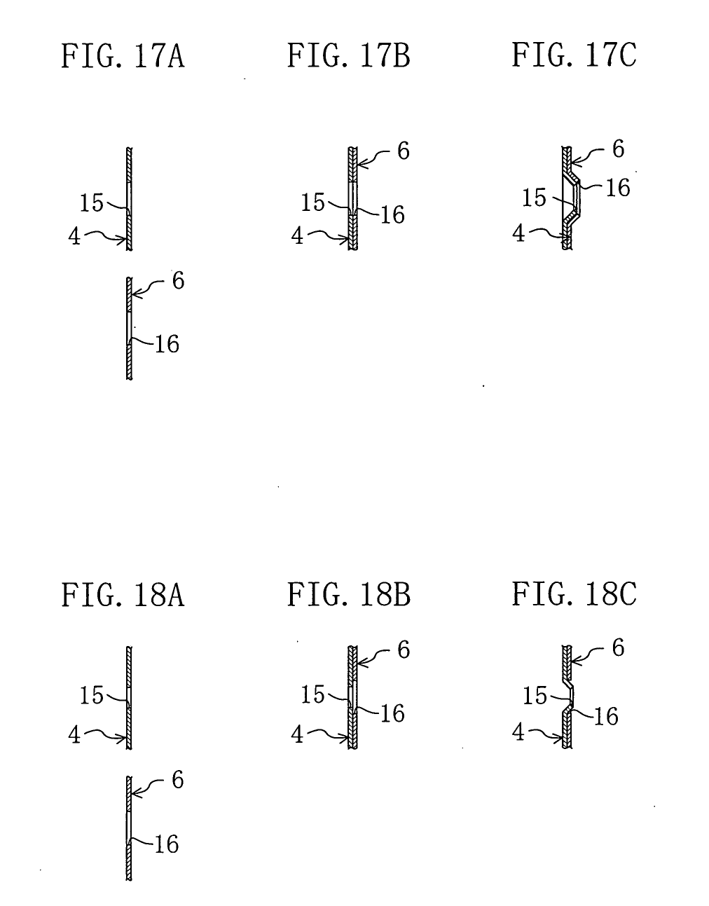

Referring to Modified Example 2 shown in FIG. 17, the insertion holes 15 and the insertion holes 16 are formed in the to-be-processed portion 51 for insertion holes of the inner panel 4 and the to-be-processed portion 53 for insertion holes of the latch mounting portion reinforcing member 6, respectively, in the primary processing step (see FIG. 17A). In Modified Example 2, after the insertion holes 15, 16 are formed, the inner panel 4 and the latch mounting portion reinforcing member 6 are positioned relative to each other with the use of the insertion holes 15, 16 as positioning references, and then, the inner panel 4 and the latch mounting portion reinforcing member 6 are joined and integrated (see FIG. 17B). Thereafter, the inner panel 4 and the latch mounting portion reinforcing member 6 are subjected to flanging in the pressing step. The use of the insertion holes 15, 16 as the positioning references attains reliable and easy positioning of the inner panel 4 and the latch mounting portion reinforcing member 6.

In Modified Example 2, the insertion holes 15, 16 are formed in the inner panel 4 and the latch mounting portion reinforcing member 6, respectively, in the primary processing step, enabling positioning of the intermediate article S obtained through the joining step to the pressing apparatus 23 by the processing tool 52. Specifically, the positioning pin (not shown) extending in the direction where the processing tool 52 protrudes is provided at the tip end (the upper side in FIG. 8) of the processing tool 52 coaxially with the processing tool 52. The tip end of the positioning pin is tapered and is set to have an outer diameter slightly smaller than the inner diameters of the insertion holes 15, 16. After the material handling robot 24 grips and conveys the intermediate article S to the pressing apparatus 23, the to-be-processed portion 53 of the latch mounting portion reinforcing member 6 is allowed to be in contact with the upper die 40, that is, the molding face of the fixed die. Then, the lower die 41 is raised so that the positioning pin of the processing tool 52 is inserted from the tip end thereof into the insertion holes 15 and the insertion holes 16 sequentially. Whereby, the inner panel 4 and the latch mounting portion reinforcing member 6 are positioned against the mold 42 with the positioning pin inserted in the insertion holes 15 and the insertion holes 16. Thus, the simple arrangement by providing the positioning pin to the processing tool 52 attains reliable positioning of the intermediate article S. Thereafter, the positioned intermediate article S is subjected to flanging by the processing tool 52.

Referring to Modified Example 3 shown in FIG. 18, the insertion holes 15 are formed in the to-be-processed portion 51 for insertion holes of the inner panel 4 while insertion holes 16 larger than the insertion holes 15 are formed in the to-be-processed portion 53 for insertion holes of the latch mounting portion reinforcing member 6 in the primary processing step (see FIG. 18A). In Modified Example 3, after formation of the insertion holes 15, 16, the inner panel 4 and the latch mounting portion reinforcing member 6 are joined (see FIG. 18B), and then in the pressing step, only the inner panel 4 is subjected to flanging so as to have a shape corresponding to the insertion holes 16.

In the above embodiments, as shown in FIG. 3, the three insertion holes 15 are formed in the inner panel 4 while the three insertion holes 16 are formed in the latch mounting portion reinforcing member 6 so as to correspond to the insertion holes 15. In this case, the respective three insertion holes 15, 16 may be formed one by one sequentially by a pressing apparatus 23 including a single processing tool 52 (processing section) as shown in FIG. 8. In detail, the material handling robot 24 grips and conveys the inner panel 4 and the latch mounting portion reinforcing member 6, and then, a first to-be-processed portion is positioned in the vicinity of the processing tool 52 of the pressing apparatus 23 and is subjected to pressing. Subsequently, the inner panel 4 and the latch mounting portion reinforcing member 6 are moved so that a second to-be-processed portion is positioned and is subjected to pressing similarly. Thereafter, a third to-be-processed portion is subjected to pressing similarly.

Alternatively, the respective three insertion holes 15, 16 may be formed one by one sequentially in such a manner that the material handling robot 24 grips and conveys the pressing apparatus 23 including the single processing tool 52 so that the pressing apparatus 23 is moved without moving the inner panel 4 and the latch mounting portion reinforcing member 6. In other words, the pressing apparatus 23 is placed against the first to-be-processed portion for performing pressing thereon, is moved to the second to-be-processing portion for performing pressing thereon, and then, is moved to the third-to-be-processed portion for performing pressing thereon similarly.

The pressing apparatus 23 including the single processing tool 52 needs a small hydraulic cylinder as a power source and, therefore, is compact, lightweight, and at low cost when compared with a pressing apparatus including a plurality of processing tools. With such a low-cost pressing apparatus employed for forming the insertion holes 15, 16, the initial capital investment required for introducing the manufacturing system 1 of the present embodiment can be suppressed.

The present invention is applicable to manufacture of a slide door or a hatchback door and manufacture of a trunk lid, bonnet hood, or the like, in addition to the doors. Further, the present invention is applicable to manufacture of a vehicle lid body for those other than automobiles.

As described above, the method and the system for manufacturing a vehicle lid body according to the present invention is employable for manufacturing a door arranged at the side of an automobile, for example.

What is claimed is:

1. A method for manufacturing a vehicle lid body for opening/closing an opening portion formed in a vehicle, comprising:
a joining step of joining and integrating by a joining apparatus a first lid body composing member and a second lid body composing member, in which a first to-be-processed portion and a second to-be-processed portion are set respectively, with the first to-be-processed portion and the second to-be-processed portion overlaid with each other in a thickness direction thereof, the first lid body composing member and the second lid body composing member being formed by stamping metal plates so as to have predetermined shapes;
a setting step of putting off the first lid body composing member and the second lid body composing member, which are integrated in the joining step, from the joining apparatus, conveying them to a pressing apparatus, and setting them against the pressing apparatus by a conveying apparatus; and
a pressing step of simultaneously pressing by the pressing apparatus the first to-be-processed portion of the first lid body composing member and the second to-be-processed portion of the second lid body composing member, which are set against the pressing apparatus in the setting step.

2. The method for manufacturing a vehicle lid body of claim 1, further comprising the step of:
forming holes by piercing the first to-be-processed portion and the second to-be-processed portion before the joining step,
wherein in the joining step, the first lid body composing member and the second lid body composing member are joined and integrated by spot welding after the first lid body composing member and the second lid body composing member are positioned relatively to each other with the use of the holes formed in the first to-be-processed portion and the second to-be-processed portion as positioning references, and
in the pressing step, the first to-be-processed portion and the second to-be-processed portion are subjected to flanging.

3. A system for manufacturing a vehicle lid body for opening/closing an opening portion formed in a vehicle, comprising:
a joining apparatus for joining and integrating a first lid body composing member and a second lid body composing member with the first lid body composing member and the second lid body composing member overlaid with each other in a thickness direction thereof, the first lid body composing member and the second lid body composing member being formed by molding metal plates so as to have predetermined shapes;
a pressing apparatus for simultaneously pressing a first to-be-processed portion of the first lid body composing member and a second to-be-processed portion of the second lid body composing member which are set respectively in parts where the first lid body composing member and the second lid body composing member are overlaid in the thickness direction thereof; and
a conveying apparatus for putting off the first lid body composing member and the second lid body composing member, which are integrated by the joining apparatus, from the joining apparatus and for conveying them to the pressing apparatus.

4. The system for manufacturing a vehicle lid body of claim 3,
wherein the pressing apparatus includes a processing section,
the first to-be-processed portion includes a plurality of first-to-be-processed portions set in the first lid body composing member and the second to-be-processed portion includes a plurality of second to-be-processed portions set in the second lid body composing member, and
the conveying apparatus conveys the first lid body composing member and the second lid body composing member so that the plurality of first to-be-processed portions and the plurality of second to-be-processed portions are set against the processing section of the pressing apparatus sequentially.

5. A system for manufacturing a vehicle lid body for opening/closing an opening portion formed in a vehicle, comprising:
a jig for holding a first lid body composing member and a second lid body composing member with the first lid body composing member and the second lid body composing member overlaid with each other in a thickness direction thereof, the first lid body composing member and the second lid body composing member being formed by stamping metal plates so as to have predetermined shapes;
a joining apparatus for joining and integrating the first lid body composing member and the second lid body composing member which are held by the jig; and
a pressing apparatus mounted to the jig for simultaneously pressing a first to-be-processed portion and a second to-be-processed portion which are set respectively in parts of the first lid body composing member and the second lid body composing member where the first lid body composing member and the second lid body composing member are overlaid with each other in the thickness direction thereof.

6. A system for manufacturing a vehicle lid body for opening/closing an opening portion formed in a vehicle, comprising:
a jig for holding a first lid body composing member and a second lid body composing member with the first lid body composing member and the second lid body composing member overlaid with each other in a thickness direction thereof, the first lid body composing member and the second lid body composing member being formed by stamping metal plates so as to have predetermined shapes;
a joining apparatus for joining and integrating the first lid body composing member and the second lid body composing member which are held by the jig;
a movable pressing apparatus for simultaneously pressing a first to-be-processed portion and a second to-be-processed portion which are set respectively in parts of the first lid body composing member and the second lid body composing member where the first lid body composing member and the second lid body composing member are overlaid with each other in the thickness direction thereof; and
a moving apparatus for moving the pressing apparatus.

7. The system for manufacturing a vehicle lid body of claim 6,
wherein the pressing apparatus includes a pressing section,
the first to-be-processed portion includes a plurality of first-to-be-processed portions set in the first lid body composing member and the second to-be-processed portion includes a plurality of second to-be-processed portions set in the second lid body composing member, and
the moving apparatus moves the pressing apparatus including the processing section to the plurality of first to-be-processed portions and the plurality of second to-be-processed portions sequentially.
